(19) United States
(12) Patent Application Publication
(10) Pub. No.: US 2024/0051825 A1
(43) Pub. Date: Feb. 15, 2024

(54) METHOD FOR PRODUCING A SYNTHESIS GAS MIXTURE

(71) Applicant: BASF SE, Ludwigshagen am Rhein (DE)

(72) Inventors: Andre BADER, Ludwigshafen am Rhein (DE); Martin GALL, Ludwigshafen am Rhein (DE)

(21) Appl. No.: 18/283,886

(22) PCT Filed: Mar. 24, 2022
(86) PCT No.: PCT/EP2022/057835

§ 371 Date: Sep. 25, 2023

(30) Foreign Application Priority Data
Mar. 26, 2021 (EP) 21165323.3

(51) Int. Cl. C01B 3/36; C01B 32/40

(52) U.S. Cl. CPC C01B 3/36; C01B 32/40; C01B 2203/0255; C01B 2203/1235

(57) ABSTRACT

A process for producing a synthesis gas mixture comprising hydrogen and carbon monoxide by noncatalytic partial oxidation of hydrocarbons in the presence of oxygen and carbon dioxide, in which at least one reactant gas comprising hydrocarbons, an oxygen-comprising reactant gas and a carbon dioxide-comprising reactant gas are fed into a partial oxidation reactor and reacted at a temperature in the range from 1200 to 1550° C. to give a product gas mixture comprising water, carbon monoxide and carbon dioxide, at least by separating a portion of the carbon dioxide from the product gas mixture and recycling it into the partial oxidation reactor, wherein the carbon dioxide fed into the partial oxidation reactor comprises additional imported carbon dioxide, giving a product gas mixture in the partial oxidation reactor that has a molar ratio of hydrogen to carbon monoxide in the range from 0.8:1 to 1.6:1.

The invention relates to a process for producing a synthesis gas mixture.

In many chemical syntheses conducted on an industrial scale, not only the product of value but also carbon-containing by-products are obtained, which are utilized solely by thermal means, in order, for example, to preheat reactants or to raise steam. The combustion of the by-products gives rise to CO₂. Physical utilization of the by-products can reduce the formation of the greenhouse gas CO₂ if the energy demand that has previously been provided by the thermal utilization of by-products is made available by the utilization of renewable energy sources.

Physical utilization of by-product streams can be enabled by specific gasification technologies in which the by-product stream is reacted together with gasifying means such as pure oxygen, steam and/or CO₂ to give synthesis gas, comprising carbon monoxide (CO) and hydrogen (H₂) as components of value. In the known gasification methods, fossil energy carriers such as coal, refinery residues (HVR—heavy vacuum residue) or natural gas, or biogenic substances such as wood or straw, are converted to a synthesis gas in a gasifier. A disadvantage is that the conversion is accomplished with formation of CO₂.

However, it is possible to recycle CO₂ formed into the gasification after it has been separated off. This simultaneously affects the resulting H₂/CO ratio of the product synthesis gas.

Carbon-containing feedstocks such as coal, refinery residues or gaseous substances such as natural gas are partially oxidized in a noncatalytic water thermal high-temperature and high-pressure method in a gasifier (POX method). This converts the carbon present to carbon monoxide and carbon dioxide for the most part. Carbon dioxide is one product of value, hydrogen the other. The amount produced depends on the amount of hydrogen bound in the feedstock and the amount of steam added. The purified product gas stream consisting essentially of hydrogen and carbon monoxide is referred to as synthesis gas. The H₂/CO ratio may vary. It depends on the feedstock used and on the gasification method chosen, and for coal may be 0.6-0.8, for HVR 0.8-1.0, and for natural gas 1.5-1.9.

H₂/CO ratios of industrial relevance are, for example, H₂/CO=1.0:1 for the oxo process (hydroformylation) or H₂/CO=2.1:1 for methanol synthesis. If the gasifier should produce a synthesis gas with H₂/CO<1.0:1, the ratio can be raised by a downstream CO shift process (CO+H₂O→CO₂+H₂). This generates considerable amounts of additional CO₂. If the gasifier should produce a greater H₂/CO ratio than required, the excess H₂ can be separated off by cryogenic distillative separation, by pressure swing adsorption or by membranes.

In the gasification of refinery residues (HVR), the liquid feedstock is atomized together with steam and partially oxidized with pure oxygen, so as to form a synthesis gas with about H₂/CO=1:1. A by-product formed is about 0.3 t of CO₂ per t of synthesis gas, which is released as emissions. Partial oxidation under these conditions reaches temperatures at the reactor outlet of 1200 to 1550° C., for example 1300-1500° C., which bring about full methane conversion with methane contents at the reactor outlet of <1.5% by volume. This low methane concentration is an essential quality feature of the synthesis gas since excessively large methane contents in downstream processes can lead to difficulties.

In the gasification of natural gas (NG), the latter is partially oxidized together with pure oxygen, with moderation of the flame with steam, so as to form a synthesis gas with a H₂/CO ratio of about 1.9:1. This also forms 0.2 t of CO₂ per t of synthesis gas, which is released as CO₂ emissions. This partial oxidation also reaches temperatures at the reactor outlet of 1200 to 1550° C., which bring about virtually full methane conversion with methane contents at the reactor outlet of <1.5% by volume.

In the gasification of natural gas, it is also possible to recycle all CO₂ formed as a by product, such that no CO₂ emissions are released. This affords a synthesis gas with H₂/CO=1.5:1 at the reactor outlet. A subsequent removal of H₂, it is possible to establish the desired H₂/CO ratio and hence obtain, for example, a synthesis gas with H₂/CO=1:1.

In the gasification of natural gas, it is also possible to import additional CO₂ via what is called the ATR (autothermal reforming) method, in addition to CO₂ recycling. It is possible here to set a H₂/CO ratio in the range of 0.9-1.5:1 without releasing CO₂ emissions. In the ATR mode of operation, a catalyst bed is used to assist the conversion. However, this allows only temperatures of 1000° C. at maximum in the catalyst bed, since the catalyst would otherwise be damaged. The lower temperatures by comparison result in incomplete methane conversion, such that 2-4% by volume of methane is still present in the reactor outlet gas.

It is an object of the invention to provide a process for producing synthesis gas in which a synthesis gas having a H₂/CO ratio suitable for the oxo process is obtained. It is a further object of the invention to physically utilize carbon-containing streams of matter that are obtained as by-products and would otherwise be utilized thermally and hence to reduce CO₂ emissions overall. It is additionally an object of the invention to provide a process for producing synthesis gas that can function as a CO₂ sink.

The object is achieved by a process for producing a synthesis gas mixture comprising hydrogen and carbon monoxide by noncatalytic partial oxidation of hydrocarbons in the presence of oxygen and carbon dioxide, in which at least one reactant gas comprising hydrocarbons, an oxygen-comprising reactant gas and a carbon dioxide-comprising reactant gas are fed into a partial oxidation reactor and reacted at a temperature in the range from 1200 to 1550° C. to give a product gas mixture comprising water, carbon monoxide and carbon dioxide, at least by separating a portion of the carbon dioxide from the product gas mixture and recycling it into the partial oxidation reactor, wherein the carbon dioxide fed into the partial oxidation reactor comprises additional imported carbon dioxide, giving a product gas mixture in the partial oxidation reactor that has a molar ratio of hydrogen to carbon monoxide in the range from 0.8:1 to 1.6:1.

Hydrocarbons in the context of the invention are carbon- and hydrogen-comprising compounds, and may also comprise oxygenates such as methanol, ethanol and dimethyl ether. These are frequently present as secondary components in the hydrocarbon-containing reactant streams. In general, the reactant hydrocarbons comprise at least 80% by volume of hydrocarbons comprising solely C and H, such as alkanes, cycloalkanes, alkenes and aromatic hydrocarbons; they preferably comprise at least 80% by weight of alkanes (straight-chain, branched and optionally cyclic alkanes) having generally 1 to 6 carbon atoms.

The novel process enables the generation of a synthesis gas with consumption of CO₂.

The additional import of further CO₂ coming from external sources makes it possible to optimize the H₂/CO ratio. It is even possible to set the H₂/CO ratio of about 1:1 which is required for the oxo process directly in the synthesis gas generation stage without downstream enrichment or depletion stages. The noncatalytic performance of the process at temperatures in the range from 1200 to 1550° C., preferably 1250 to 1400° C., achieves virtually complete methane conversion. The methane content at the outlet from the synthesis gas reactor is generally <1.5% by volume, preferably <0.2% by volume or even <0.05% by volume.

The process of the invention allows the physical utilization of carbon-containing by-product streams and of CO₂ released in any other production processes, which binds a maximum amount of carbon within the synthesis gas. If required process heat or mechanical process energy is provided by renewable energy sources, thermal utilized carbon-containing by-product streams are otherwise released for physical utilization. Carbon-containing streams of matter that would otherwise have been incinerated with release of CO₂ for the generation of heat or raising of steam may be used in accordance with the invention as feedstock for synthesis gas production. High hydrogen to carbon ratios are advantageous in the reactant hydrocarbons since large amounts of carbon dioxide are then imported into the process and can be utilized physically. The optimal reactant hydrocarbon is methane with a hydrogen to carbon ratio of 4:1.

Gaseous or liquid hydrocarbon-containing reactants and the gasifying agents oxygen and carbon dioxide as further reactants flow through the high-temperature partial oxidation reactor used in accordance with the invention. The reaction generally takes place under high pressure for the implementation of high throughputs, generally at pressures of 1 to 100 bar, preferably of 10 to 60 bar, more preferably 20 to 60 bar. The interior of the partial oxidation reactor is generally cylindrical, with one or more burners present on the outer faces. In the region of the oxygen input (flame), local temperatures of more than 2000° C. are possible.

The endothermic gas reforming reaction (dry reforming, empirical equation: CH₄+CO₂→2CO+2H₂) cools down the gas phase, and reactor outlet temperatures of 1200 to 1550° C. are attained. This gas reforming reaction at 1200 to 1550° C., preferably 1250 to 1400° C., achieves the high synthesis gas yield and virtually complete hydrocarbon conversion (especially methane conversion).

The carbon dioxide generated in the gasifier (partial oxidation reactor, synthesis gas reactor) in the partial oxidation is subsequently separated from the crude synthesis gas by gas scrubbing and recycled into the gasifier. The gas scrubbing can be effected according to prior art. The crude synthesis gas is scrubbed in countercurrent with an amine-containing scrubbing agent in a scrubbing column, with virtually complete absorption of the CO₂ present in the crude synthesis gas by the amine. For this purpose, the crude synthesis gas is cooled down to 30-70° C. before entry into the scrubbing column in order to avoid thermal stress on the amine. The CO₂-enriched scrubbing agent is subsequently regenerated in a desorber column with supply of heat. The regenerated scrubbing agent can be used again in the scrubbing column in circulation mode. The CO₂ leaves the desorber column generally at ambient pressure at the top of the column. In order to recycle the CO₂ into the partial oxidation reactor, it is brought to system pressure beforehand in a compressor.

Depending on the H₂/CO ratio required, according to the invention, additional CO₂ is imported from external sources. The richer in CO the desired synthesis gas is to be, i.e. the lower the desired H₂/CO ratio, the more CO₂ can be used from external sources and utilized physically. The richer in hydrogen the hydrocarbon-containing by-product stream used, the more CO₂ can be imported from external sources in order to establish a particular H₂/CO ratio.

In general, the molar proportions of the CₓH_{y}/CO₂/O₂ reactants fed to the partial oxidation process, including the recycled CO₂, depending on the H/C ratio in the reactant hydrocarbon stream, are 0.19-0.57/0.02-0.30/0.31-0.70, depending on the desired H₂/CO ratio in the crude synthesis gas. Illustrative molar proportions of CxHy/CO₂/O₂ (mol/Σmol; total of 1.0) are shown in table 1 table 9 below for various reactant hydrocarbons and various H2/CO ratios, for reactor outlet temperature 1250° C. to 1450° C., and for pressures of 10, 46 and 100 bar(a).

TABLE 1
Reactant compositions for the gasifier in mol/mol for various H2/CO
ratios for a reactor outlet temperature of 1250° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.44 | 0.35 | 0.31 | 0.27 | 0.24 |
| CO2/reactant gas | 0.24 | 0.22 | 0.17 | 0.15 | 0.13 |
| O2/reactant gas | 0.33 | 0.43 | 0.52 | 0.59 | 0.63 |
| H2/CO in syngas | 0.8:1 | 0.8:1 | 0.8:1 | 0.8:1 | 0.8:1 |
| CxHy/reactant gas | 0.39 | 0.31 | 0.26 | 0.22 | 0.19 |
| CO2/reactant gas | 0.30 | 0.29 | 0.28 | 0.28 | 0.27 |
| O2/reactant gas | 0.31 | 0.40 | 0.46 | 0.50 | 0.54 |
| H2/CO in syngas | 1.6:1 | 1.3:1 | 1.2:1 | 1.2:1 | 1.1:1 |
| CxHy/reactant gas | 0.57 | 0.45 | 0.37 | 0.32 | 0.28 |
| CO2/reactant gas | 0.05 | 0.04 | 0.03 | 0.03 | 0.02 |
| O2/reactant gas | 0.38 | 0.51 | 0.60 | 0.66 | 0.70 |

TABLE 2
Reactant compositions for the gasifier in mol/mol for various H2/CO
ratios for a reactor outlet temperature of 1350° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.44 | 0.36 | 0.31 | 0.27 | 0.24 |
| CO2/reactant gas | 0.21 | 0.18 | 0.15 | 0.13 | 0.11 |
| O2/reactant gas | 0.34 | 0.46 | 0.54 | 0.60 | 0.65 |
| H2/CO in syngas | 0.8:1 | 0.8:1 | 0.8:1 | 0.8:1 | 0.8:1 |
| CxHy/reactant gas | 0.40 | 0.32 | 0.26 | 0.22 | 0.19 |
| CO2/reactant gas | 0.28 | 0.27 | 0.26 | 0.25 | 0.25 |
| O2/reactant gas | 0.32 | 0.41 | 0.48 | 0.53 | 0.56 |
| H2/CO in syngas | 1.6:1 | 1.3:1 | 1.2:1 | 1.2:1 | 1.1:1 |
| CxHy/reactant gas | 0.56 | 0.44 | 0.36 | 0.30 | 0.26 |
| CO2/reactant gas | 0.05 | 0.04 | 0.04 | 0.03 | 0.03 |
| O2/reactant gas | 0.39 | 0.52 | 0.60 | 0.66 | 0.71 |

TABLE 3
Reactant compositions for the gasifier in mol/mol for various H2/CO
ratios for a reactor outlet temperature of 1450° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.45 | 0.37 | 0.31 | 0.27 | 0.24 |
| CO2/reactant gas | 0.20 | 0.16 | 0.13 | 0.11 | 0.10 |
| O2/reactant gas | 0.36 | 0.47 | 0.56 | 0.62 | 0.67 |
| H2/CO in syngas | 0.8:1 | 0.8:1 | 0.8:1 | 0.8:1 | 0.8:1 |
| CxHy/reactant gas | 0.40 | 0.32 | 0.26 | 0.22 | 0.20 |
| CO2/reactant gas | 0.26 | 0.25 | 0.24 | 0.23 | 0.22 |
| O2/reactant gas | 0.33 | 0.43 | 0.50 | 0.55 | 0.58 |
| H2/CO in syngas | 1.5:1 | 1.3:1 | 1.2:1 | 1.1:1 | 1.1:1 |
| CxHy/reactant gas | 0.55 | 0.43 | 0.35 | 0.29 | 0.25 |
| CO2/reactant gas | 0.05 | 0.04 | 0.04 | 0.04 | 0.04 |
| O2/reactant gas | 0.40 | 0.53 | 0.61 | 0.67 | 0.71 |

TABLE 4
Reactant compositions for the gasifier in mol/mol for various H2/CO
ratios for a reactor outlet temperature of 1250° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.44 | 0.36 | 0.31 | 0.27 | 0.24 |
| CO2/reactant gas | 0.23 | 0.20 | 0.17 | 0.15 | 0.14 |
| O2/reactant gas | 0.33 | 0.43 | 0.52 | 0.58 | 0.63 |
| H2/CO in syngas | 0.8:1 | 0.8:1 | 0.8:1 | 0.8:1 | 0.8:1 |
| CxHy/reactant gas | 0.39 | 0.31 | 0.26 | 0.22 | 0.19 |
| CO2/reactant gas | 0.30 | 0.30 | 0.29 | 0.28 | 0.27 |
| O2/reactant gas | 0.30 | 0.39 | 0.46 | 0.50 | 0.54 |
| H2/CO in syngas | 1.6:1 | 1.4:1 | 1.2:1 | 1.2:1 | 1.2:1 |
| CxHy/reactant gas | 0.57 | 0.46 | 0.37 | 0.31 | 0.27 |
| CO2/reactant gas | 0.05 | 0.03 | 0.03 | 0.02 | 0.02 |
| O2/reactant gas | 0.39 | 0.51 | 0.60 | 0.66 | 0.71 |

TABLE 5
Reactant compositions for the gasifier in mol/mol for various H2/CO
ratios for a reactor outlet temperature of 1350° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.44 | 0.36 | 0.31 | 0.27 | 0.24 |
| CO2/reactant gas | 0.21 | 0.18 | 0.15 | 0.13 | 0.12 |
| O2/reactant gas | 0.34 | 0.45 | 0.54 | 0.60 | 0.65 |
| H2/CO in syngas | 0.8:1 | 0.8:1 | 0.8:1 | 0.8:1 | 0.8:1 |
| CxHy/reactant gas | 0.40 | 0.32 | 0.26 | 0.22 | 0.19 |
| CO2/reactant gas | 0.28 | 0.28 | 0.26 | 0.25 | 0.25 |
| O2/reactant gas | 0.32 | 0.41 | 0.48 | 0.52 | 0.56 |
| H2/CO in syngas | 1.6:1 | 1.3:1 | 1.2:1 | 1.2:1 | 1.1:1 |
| CxHy/reactant gas | 0.56 | 0.45 | 0.36 | 0.30 | 0.26 |
| CO2/reactant gas | 0.05 | 0.04 | 0.04 | 0.03 | 0.03 |
| O2/reactant gas | 0.39 | 0.52 | 0.61 | 0.66 | 0.71 |

TABLE 6
Reactant compositions for the gasifier in mol/mol for various H2/CO
ratios for a reactor outlet temperature of 1450° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.45 | 0.37 | 0.31 | 0.27 | 0.24 |
| CO2/reactant gas | 0.20 | 0.17 | 0.13 | 0.11 | 0.10 |
| O2/reactant gas | 0.35 | 0.47 | 0.56 | 0.62 | 0.67 |
| H2/CO in syngas | 0.8:1 | 0.8:1 | 0.8:1 | 0.8:1 | 0.8:1 |
| CxHy/reactant gas | 0.40 | 0.32 | 0.26 | 0.22 | 0.20 |
| CO2/reactant gas | 0.26 | 0.25 | 0.24 | 0.23 | 0.23 |
| O2/reactant gas | 0.33 | 0.43 | 0.50 | 0.54 | 0.58 |
| H2/CO in syngas | 1.5:1 | 1.3:1 | 1.2:1 | 1.1:1 | 1.1:1 |
| CxHy/reactant gas | 0.55 | 0.43 | 0.35 | 0.29 | 0.25 |
| CO2/reactant gas | 0.05 | 0.04 | 0.04 | 0.04 | 0.04 |
| O2/reactant gas | 0.40 | 0.52 | 0.61 | 0.67 | 0.71 |

TABLE 7
Reactant compositions for the gasifier in mol/mol
for various H2/CO ratios for a reactor outlet
temperature of 1250° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.44 | 0.37 | 0.32 | 0.28 | 0.26 |
| CO2/reactant gas | 0.23 | 0.19 | 0.16 | 0.13 | 0.09 |
| O2/reactant gas | 0.33 | 0.44 | 0.53 | 0.59 | 0.65 |
| H2/CO in syngas | 0.8:1 | 0.8:1 | 0.8:1 | 0.8:1 | 0.8:1 |
| CxHy/reactant gas | 0.39 | 0.31 | 0.26 | 0.22 | 0.20 |
| CO2/reactant gas | 0.30 | 0.29 | 0.28 | 0.27 | 0.26 |
| O2/reactant gas | 0.31 | 0.40 | 0.46 | 0.51 | 0.54 |
| H2/CO in syngas | 1.6:1 | 1.3:1 | 1.2:1 | 1.1:1 | 1:1 |
| CxHy/reactant gas | 0.57 | 0.46 | 0.38 | 0.33 | 0.30 |
| CO2/reactant gas | 0.05 | 0.04 | 0.03 | 0.03 | 0.02 |
| O2/reactant gas | 0.38 | 0.50 | 0.58 | 0.64 | 0.68 |

TABLE 8
Reactant compositions for the gasifier in mol/mol
for various H2/CO ratios for a reactor outlet
temperature of 1350° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.45 | 0.37 | 0.31 | 0.27 | 0.24 |
| CO2/reactant gas | 0.21 | 0.18 | 0.15 | 0.12 | 0.11 |
| O2/reactant gas | 0.34 | 0.46 | 0.54 | 0.60 | 0.65 |
| H2/CO in syngas | 0.8:1 | 0.8:1 | 0.8:1 | 0.8:1 | 0.8:1 |
| CxHy/reactant gas | 0.40 | 0.32 | 0.26 | 0.22 | 0.20 |
| CO2/reactant gas | 0.28 | 0.27 | 0.26 | 0.25 | 0.24 |
| O2/reactant gas | 0.32 | 0.42 | 0.48 | 0.53 | 0.56 |
| H2/CO in syngas | 1.6:1 | 1.3:1 | 1.2:1 | 1.1:1 | 1.1:1 |
| CxHy/reactant gas | 0.56 | 0.44 | 0.36 | 0.31 | 0.27 |
| CO2/reactant gas | 0.05 | 0.04 | 0.04 | 0.04 | 0.03 |
| O2/reactant gas | 0.39 | 0.52 | 0.60 | 0.66 | 0.70 |

TABLE 9
Reactant compositions for the gasifier in mol/mol
for various H2/CO ratios for a reactor outlet
temperature of 1450° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.45 | 0.37 | 0.31 | 0.27 | 0.24 |
| CO2/reactant gas | 0.19 | 0.16 | 0.13 | 0.11 | 0.09 |
| O2/reactant gas | 0.36 | 0.47 | 0.56 | 0.62 | 0.67 |
| H2/CO in syngas | 0.8:1 | 0.8:1 | 0.8:1 | 0.8:1 | 0.8:1 |
| CxHy/reactant gas | 0.40 | 0.32 | 0.26 | 0.23 | 0.20 |
| CO2/reactant gas | 0.26 | 0.25 | 0.24 | 0.23 | 0.22 |
| O2/reactant gas | 0.34 | 0.43 | 0.50 | 0.55 | 0.58 |
| H2/CO in syngas | 1.5:1 | 1.3:1 | 1.2:1 | 1.1:1 | 1.1:1 |
| CxHy/reactant gas | 0.55 | 0.43 | 0.35 | 0.29 | 0.26 |
| CO2/reactant gas | 0.05 | 0.05 | 0.04 | 0.04 | 0.04 |
| O2/reactant gas | 0.40 | 0.53 | 0.61 | 0.66 | 0.71 |

According to the invention, the molar ratio of hydrogen and carbon monoxide in the product gas mixture from the partial oxidation is in the range from 0.8:1 to 1.6:1. The molar ratio of hydrogen to carbon monoxide is preferably from 0.8:1 to 1.2:1, more preferably from 0.9:1 to 1.1:1.

Table 10 to table 18 below, showing the molar proportions of CₓH_{y}/CO₂/O₂ (mol/mol; total of 1.0), takes account only of the amount of CO₂ imported into partial oxidation process (without recycled CO₂). The greater the H/C ratio in the reactant hydrocarbon, the lower the react outlet temperature set and the lower the system pressure, the more CO₂ can be imported into the process from external sources.

The carbon-containing component is preferably methane. For example, the molar proportions of the CH₄/CO₂/O₂ reactants fed to the partial oxidation process, without the recycled CO₂, are 0.50/0.13/0.37. Methane is reactant hydrocarbon thus enables the greatest CO₂ import at a H₂/CO ratio of 1:1 in the synthesis gas. This can be used directly, i.e. without further enrichment or depletion stages, in downstream syntheses (oxo processes, hydroformylations). With pure methane as reactant hydrocarbon, it is possible to physically utilize 0.30 tonne of imported CO₂ per tonne of synthesis gas (H₂:CO=1:1). This amount falls with increasing chain length of the reactant hydrocarbon, and for ethane is still 0.20 t CO₂/t, for propane 0.13 t CO₂/t, for butane 0.10 t CO₂/t, and for pentane 0.08 t CO₂/t.

TABLE 10
Reactant compositions for the partial oxidation process
in mol/mol for various H2/CO ratios for a reactor
outlet temperature of 1250° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.39 | 0.33 | 0.29 | 0.25 |
| CO2 (import)/reactant | 0.13 | 0.12 | 0.10 | 0.08 | 0.08 |
| O2/reactant gas | 0.37 | 0.48 | 0.57 | 0.63 | 0.67 |
| H2/CO in syngas | 0.8:1 | 0.8:1 | 0.8:1 | 0.8:1 | 0.8:1 |
| CxHy/reactant gas | 0.47 | 0.36 | 0.30 | 0.25 | 0.22 |
| CO2 (import)/reactant | 0.16 | 0.17 | 0.17 | 0.17 | 0.17 |
| O2/reactant gas | 0.37 | 0.46 | 0.53 | 0.58 | 0.61 |
| H2/CO in syngas | 1.6:1 | 1.3:1 | 1.2:1 | 1.2:1 | 1.1:1 |
| CxHy/reactant gas | 0.60 | 0.41 | 0.38 | 0.33 | 0.29 |
| CO2 (import)/reactant | 0.00 | 0.00 | 0.00 | 0.00 | 0.00 |
| O2/reactant gas | 0.40 | 0.59 | 0.62 | 0.67 | 0.71 |

TABLE 11
Reactant compositions for the partial oxidation process
in mol/mol for various H2/CO ratios for a reactor
outlet temperature of 1350° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.11 | 0.10 | 0.08 | 0.07 | 0.06 |
| O2/reactant gas | 0.39 | 0.50 | 0.59 | 0.64 | 0.69 |
| H2/CO in syngas | 0.8:1 | 0.8:1 | 0.8:1 | 0.8:1 | 0.8:1 |
| CxHy/reactant gas | 0.47 | 0.36 | 0.30 | 0.25 | 0.22 |
| CO2 (import)/reactant | 0.15 | 0.16 | 0.15 | 0.15 | 0.15 |
| O2/reactant gas | 0.38 | 0.48 | 0.55 | 0.60 | 0.63 |
| H2/CO in syngas | 1.6:1 | 1.3:1 | 1.2:1 | 1.1:1 | 1.1:1 |
| CxHy/reactant gas | 0.59 | 0.46 | 0.37 | 0.31 | 0.27 |
| CO2 (import)/reactant | 0.00 | 0.00 | 0.00 | 0.00 | 0.00 |
| O2/reactant gas | 0.41 | 0.54 | 0.63 | 0.69 | 0.73 |

TABLE 12
Reactant compositions for the partial oxidation process
in mol/mol for various H2/CO ratios for a reactor
outlet temperature of 1450° C. and at 46 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.10 | 0.08 | 0.06 | 0.05 | 0.04 |
| O2/reactant gas | 0.40 | 0.52 | 0.60 | 0.66 | 0.71 |
| H2/CO in syngas | 0.8:1 | 0.8:1 | 0.8:1 | 0.8:1 | 0.8:1 |
| CxHy/reactant gas | 0.47 | 0.37 | 0.30 | 0.25 | 0.22 |
| CO2 (import)/reactant | 0.14 | 0.14 | 0.14 | 0.13 | 0.13 |
| O2/reactant gas | 0.39 | 0.49 | 0.56 | 0.61 | 0.65 |
| H2/CO in syngas | 1.5:1 | 1.3:1 | 1.2:1 | 1.1:1 | 1.1:1 |
| CxHy/reactant gas | 0.58 | 0.45 | 0.36 | 0.31 | 0.26 |
| CO2 (import)/reactant | 0.00 | 0.00 | 0.00 | 0.00 | 0.00 |
| O2/reactant gas | 0.42 | 0.55 | 0.64 | 0.69 | 0.74 |

TABLE 13
Reactant compositions for the partial oxidation process
in mol/mol for various H2/CO ratios for a reactor
outlet temperature of 1250° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.13 | 0.12 | 0.10 | 0.09 | 0.08 |
| O2/reactant gas | 0.37 | 0.48 | 0.57 | 0.63 | 0.67 |
| H2/CO in syngas | 0.8:1 | 0.8:1 | 0.8:1 | 0.8:1 | 0.8:1 |
| CxHy/reactant gas | 0.47 | 0.36 | 0.30 | 0.25 | 0.22 |
| CO2 (import)/reactant | 0.17 | 0.18 | 0.17 | 0.17 | 0.17 |
| O2/reactant gas | 0.37 | 0.46 | 0.53 | 0.58 | 0.61 |
| H2/CO in syngas | 1.6:1 | 1.4:1 | 1.2:1 | 1.2:1 | 1.2:1 |
| CxHy/reactant gas | 0.60 | 0.47 | 0.38 | 0.32 | 0.28 |
| CO2 (import)/reactant | 0.00 | 0.00 | 0.00 | 0.00 | 0.00 |
| O2/reactant gas | 0.40 | 0.53 | 0.62 | 0.68 | 0.72 |

TABLE 14
Reactant compositions for the partial oxidation process
in mol/mol for various H2/CO ratios for a reactor
outlet temperature of 1350° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.12 | 0.11 | 0.08 | 0.07 | 0.06 |
| O2/reactant gas | 0.38 | 0.49 | 0.58 | 0.64 | 0.69 |
| H2/CO in syngas | 0.8:1 | 0.8:1 | 0.8:1 | 0.8:1 | 0.8:1 |
| CxHy/reactant gas | 0.47 | 0.36 | 0.30 | 0.25 | 0.22 |
| CO2 (import)/reactant | 0.15 | 0.16 | 0.15 | 0.15 | 0.15 |
| O2/reactant gas | 0.38 | 0.47 | 0.55 | 0.60 | 0.63 |
| H2/CO in syngas | 1.6:1 | 1.3:1 | 1.2:1 | 1.2:1 | 1.1:1 |
| CxHy/reactant gas | 0.59 | 0.46 | 0.37 | 0.31 | 0.27 |
| CO2 (import)/reactant | 0.00 | 0.00 | 0.00 | 0.00 | 0.00 |
| O2/reactant gas | 0.41 | 0.54 | 0.63 | 0.69 | 0.73 |

TABLE 15
Reactant compositions for the partial oxidation process
in mol/mol for various H2/CO ratios for a reactor
outlet temperature of 1450° C. and at 10 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.10 | 0.09 | 0.07 | 0.05 | 0.04 |
| O2/reactant gas | 0.40 | 0.51 | 0.60 | 0.66 | 0.71 |
| H2/CO in syngas | 0.8:1 | 0.8:1 | 0.8:1 | 0.8:1 | 0.8:1 |
| CxHy/reactant gas | 0.47 | 0.36 | 0.30 | 0.25 | 0.22 |
| CO2 (import)/reactant | 0.14 | 0.15 | 0.14 | 0.13 | 0.13 |
| O2/reactant gas | 0.39 | 0.49 | 0.56 | 0.61 | 0.65 |
| H2/CO in syngas | 1.5:1 | 1.3:1 | 1.2:1 | 1.1:1 | 1.1:1 |
| CxHy/reactant gas | 0.58 | 0.45 | 0.36 | 0.31 | 0.26 |
| CO2 (import)/reactant | 0.00 | 0.00 | 0.00 | 0.00 | 0.00 |
| O2/reactant gas | 0.42 | 0.55 | 0.64 | 0.69 | 0.74 |

TABLE 16
Reactant compositions for the partial oxidation process
in mol/mol for various H2/CO ratios for a reactor
outlet temperature of 1250° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.41 | 0.34 | 0.30 | 0.27 |
| CO2 (import)/reactant | 0.12 | 0.11 | 0.09 | 0.07 | 0.05 |
| O2/reactant gas | 0.38 | 0.49 | 0.57 | 0.63 | 0.68 |
| H2/CO in syngas | 0.8:1 | 0.8:1 | 0.8:1 | 0.8:1 | 0.8:1 |
| CxHy/reactant gas | 0.47 | 0.37 | 0.30 | 0.26 | 0.22 |
| CO2 (import)/reactant | 0.16 | 0.17 | 0.16 | 0.16 | 0.16 |
| O2/reactant gas | 0.37 | 0.47 | 0.53 | 0.58 | 0.62 |
| H2/CO in syngas | 1.6:1 | 1.3:1 | 1.2:1 | 1.1:1 | 1:1 |
| CxHy/reactant gas | 0.60 | 0.48 | 0.40 | 0.34 | 0.30 |
| CO2 (import)/reactant | 0.00 | 0.00 | 0.00 | 0.00 | 0.00 |
| O2/reactant gas | 0.40 | 0.52 | 0.60 | 0.66 | 0.70 |

TABLE 17
Reactant compositions for the partial oxidation process
in mol/mol for various H2/CO ratios for a reactor
outlet temperature of 1350° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.34 | 0.29 | 0.26 |
| CO2 (import)/reactant | 0.11 | 0.09 | 0.08 | 0.06 | 0.05 |
| O2/reactant gas | 0.39 | 0.50 | 0.59 | 0.65 | 0.69 |
| H2/CO in syngas | 0.8:1 | 0.8:1 | 0.8:1 | 0.8:1 | 0.8:1 |
| CxHy/reactant gas | 0.47 | 0.37 | 0.30 | 0.25 | 0.22 |
| CO2 (import)/reactant | 0.15 | 0.15 | 0.15 | 0.15 | 0.15 |
| O2/reactant gas | 0.38 | 0.48 | 0.55 | 0.60 | 0.63 |
| H2/CO in syngas | 1.6:1 | 1.3:1 | 1.2:1 | 1.1:1 | 1.1:1 |
| CxHy/reactant gas | 0.59 | 0.46 | 0.38 | 0.32 | 0.28 |
| CO2 (import)/reactant | 0.00 | 0.00 | 0.00 | 0.00 | 0.00 |
| O2/reactant gas | 0.41 | 0.54 | 0.62 | 0.68 | 0.72 |

TABLE 18
Reactant compositions for the partial oxidation process
in mol/mol for various H2/CO ratios for a reactor
outlet temperature of 1450° C. and at 100 bar(a)

| | CH4 | C2H6 | C3H8 | C4H10 | C5H12 |
|---|---|---|---|---|---|
| | (100%) | (100%) | (100%) | (100%) | (100%) |
| H2/CO in syngas | 1:1 | 1:1 | 1:1 | 1:1 | 1:1 |
| CxHy/reactant gas | 0.50 | 0.40 | 0.33 | 0.29 | 0.25 |
| CO2 (import)/reactant | 0.10 | 0.08 | 0.06 | 0.05 | 0.04 |
| O2/reactant gas | 0.40 | 0.52 | 0.60 | 0.66 | 0.71 |
| H2/CO in syngas | 0.8:1 | 0.8:1 | 0.8:1 | 0.8:1 | 0.8:1 |
| CxHy/reactant gas | 0.47 | 0.92 | 0.93 | 0.93 | 0.93 |
| CO2 (import)/reactant | 0.14 | 0.08 | 0.07 | 0.07 | 0.07 |
| O2/reactant gas | 0.39 | 0.00 | 0.00 | 0.00 | 0.00 |
| H2/CO in syngas | 1.5:1 | 1.3:1 | 1.2:1 | 1.1:1 | 1.1:1 |
| CxHy/reactant gas | 0.58 | 0.45 | 0.36 | 0.31 | 0.27 |
| CO2 (import)/reactant | 0.00 | 0.00 | 0.00 | 0.00 | 0.00 |
| O2/reactant gas | 0.42 | 0.55 | 0.64 | 0.69 | 0.73 |

The reactant gas comprising hydrocarbons for the partial oxidation preferably comprises methane. The molar ratio of hydrogen to carbon monoxide in the synthesis gas here is preferably from 0.8:1 to 1.2:1, more preferably from 0.9:1 to 1.1:1. With pure methane, it is possible to bind 0.30 t of imported, i.e. non-recycled, CO₂ per t of synthesis gas (H₂:CO=1:1).

If a hydrocarbon reactant gas consisting predominantly of methane, preferably to an extent of at least 80% by weight, more preferably to an extent of at least 90% by weight, is used, the overall molar methane:oxygen:carbon dioxide ratio in the reaction gases for the overall process, i.e. comprising imported and recycled CO₂, is preferably 0.39 to 0.57:0.30 to 0.40:0.05 to 0.30, more preferably 0.39 to 0.57:0.31 to 0.38:0.05 to 0.30.

The methane present in the reactant gas for the partial oxidation is preferably obtained in a steamcracker.

The reactant mixture used for the steamcracking process is frequently the naphtha obtained in a mineral oil refinery. The actual cracker is a tubular reactor having a pipe coil made of a chromium/nickel alloy and is in a furnace heated by flames. The reactant mixture, for example at about 12 bar, is preheated to 550 to 600° C. in the convection zone of the furnace. In this zone, process steam at 180 to 200° C. is also added. This brings about lowering of the partial pressure of the individual reaction participants and additionally prevents polymerization of the reaction products. After the convection zone, the fully gaseous reactant mixture reaches the radiation zone. It is cracked therein at 1050° C., for example, to give the low molecular weight hydrocarbons. The dwell time is, for example, about 0.2-0.4 s. This gives rise to ethene, propene, 1,2- and 1,3-butadiene, n- and i-butene, benzene, toluene, xylenes. Also formed are hydrogen and methane in considerable amounts of, for example, about 16% by weight, and other by-products, some of them disruptive, such as ethyne, propyne (in traces), propylene (in traces) and, as a constituent of pyrolysis gasoline, n-, i- and cyclo-paraffins and -olefins, C₉ and C₁₃ aromatics. The heaviest fraction is what is called ethylene cracker residue with a boiling range of, for example, 210-500° C.

In order that the reaction products do not oligomerize, hot cracking gas is cooled abruptly in a heat transfer to around 350 to 400° C. Subsequently, the hot cracking gas is additionally cooled down with quench oil to 150 to 170° C. for the subsequent fractionation.

The product stream at the furnace exit comprises a multitude of substances that are then separated from one another. The products of value, ethene and propene, are generally obtained in a very high purity. The substances that one would not wish to obtain as product are partly recycled to the cracker, partly incinerated.

The workup commences with the oil scrub and the water scrub, in which the still-hot gas is cooled down further, and heavy impurities such as coke and tar are separated out. This is followed by stepwise cooling of the cracking gas and a sequence of applications in which the hydrocarbon mixture is divided into fractions of different carbon number. The individual fractions are separated into the unsaturated and unsaturated hydrocarbons in further distillations. For the separation of the light hydrocarbons, low-temperature rectifications at high pressure are required. For this purpose, the cracking gas is first compressed stepwise to about 30 bar, for example. The acidic gases are absorbed in an alkali scrub. An adsorptive drier removes water.

The use of electrical energy from renewable energy sources for driving of previously steam-driven compressors makes it possible to dispense with the combustion of hydrocarbon-containing by-products for steam raising. These hydrocarbon-containing by-products are thus available as feedstock for the synthesis gas production of the invention.

The removal of traces of ethyne would be extremely difficult, and so ethyne is instead catalytically hydrogenated to ethene. Analogously, after the C₃ fraction has been separated off and before the propane-propene separation, the propyne and allene fractions are respectively converted to propene and propane by selective hydrogenation.

Methane can be separated from ethyne, ethene and ethane, for example, at 13 bar and −115° C.

The main products, especially ethene and propene, are obtained in pure form. The butene isomers can be used for various petrochemical processes, for example the iso-butene for production of MTBE and ETBE, n-butenes for production of alkylate. The pyrolysis gasoline is starting material for the obtaining of benzene and toluene.

Fractions that are unwanted as products, especially alkanes, can be recycled into the cracker. The fractions unsuitable for cracking, especially hydrogen and methane, have to date usually being incinerated in the cracking furnaces and meet the energy demand of the process. The tarlike residue is either incinerated in a power plant, sold as binder for production of graphite electrodes, or used for production of industrial carbon black.

In a further embodiment of the invention, the methane is obtained as by-product in the propane dehydrogenation.

In a further preferred embodiment of the invention, the carbon dioxide present in the at least one reactant gas stream is obtained in ammonia synthesis. The production of ammonia is implemented by the equilibrium reaction of hydrogen and nitrogen (N₂+3H₂→2NH₃). The hydrogen is produced on an industrial scale by the steam reforming of natural gas, which in the first step produces a synthesis gas mixture of H₂ and CO. In a subsequent water-gas shift stage (CO+H₂O→H₂+CO₂), the CO is converted with water to hydrogen and carbon dioxide. The hydrogen produced by this route produces about 10 tonnes of carbon dioxide per tonne of hydrogen. The CO₂ is removed by an acid gas scrub and, after a compression stage, is available in pure form as reactant for the partial oxidation process described here.

In a further preferred embodiment of the invention, the carbon dioxide imported into the partial oxidation reactor is obtained in ethylene oxide synthesis.

Ethylene oxide is produced on an industrial scale by the catalytic oxidation of ethene with oxygen at temperatures of 230-270° C. and pressures of 10-20 bar. The catalyst used is finely divided silver powder that has been applied to an oxidic support, preferably alumina. The reaction is conducted in a shell-and-tube reactor in which the considerable heat of reaction is removed with the aid of salt melts and is utilized for raising of superheated high-pressure steam. The yield of pure ethylene oxide is, for example, 85%. A side reaction that occurs is the complete oxidation of the ethene to carbon dioxide and water.

1.-14. (canceled)

15. A process for producing a synthesis gas mixture comprising hydrogen and carbon monoxide by noncatalytic partial oxidation of hydrocarbons in the presence of oxygen and carbon dioxide, in which at least one reactant gas comprising hydrocarbons, an oxygen-comprising reactant gas and a carbon dioxide-comprising reactant gas are fed into a partial oxidation reactor and reacted at a temperature in the range from 1200 to 1550° C. to give a product gas mixture comprising water, carbon monoxide and carbon dioxide, wherein the carbon dioxide fed into the partial oxidation reactor comprises additional imported carbon dioxide, and wherein the overall molar ratio of hydrocarbons:oxygen:carbon dioxide in the reactant gases is 0.19 to 0.57:0.31 to 0.70:0.02 to 0.30, where the reactant gas comprising hydrocarbons from the partial oxidation comprises at least 80% by weight of methane, and the overall molar ratio of hydrocarbons:oxygen:carbon dioxide in the reactant gases is 0.39 to 0.57:0.30 to 0.40:0.05 to 0.30, and wherein a product gas mixture that has a molar ratio of hydrogen to carbon monoxide in the range from 0.8:1 to 1.2:1 is obtained in the partial oxidation reactor.

16. The process according to claim 15, wherein the hydrocarbons are obtained as coproduct in production processes and are typically utilized thermally.

17. The process according to claim 16, wherein the hydrocarbons are incinerated for steam raising.

18. The process according to claim 15, wherein the imported carbon dioxide has been obtained in production processes or separated from air.

19. The process according to claim 15, wherein the hydrocarbons may additionally comprise oxygenates.

20. The process according to claim 15, the molar ratio of hydrogen to carbon monoxide in the product gas mixture is in the range from 0.9:1 to 1.1:1.

21. The process according to claim 15, wherein the overall molar ratio of methane:oxygen:carbon dioxide in the reactant gases from the partial oxidation is 0.39 to 0.57:0.31 to 0.38:0.05 to 0.30.

22. The process according to claim 15, wherein the reactant gas comprising hydrocarbons is obtained in a steam cracker, where it is preferably replaced by the use of power without or with reduced CO₂ footprint and hence made available for physical utilization.

23. The process according to claim 15, wherein the reactant gas comprising hydrocarbons is obtained as a by-product in the dehydrogenation of propane.

24. The process according to claim 15, wherein the imported carbon dioxide is obtained in ammonia synthesis.

25. The process according to claim 15, wherein the imported carbon dioxide is obtained in ethylene oxide synthesis.
